(19) United States
(12) Patent Application Publication
(10) Pub. No.: US 2014/0018966 A1
(43) Pub. Date: Jan. 16, 2014

(54) PERSONALIZED POWER RESOURCES MANAGEMENT SYSTEM AND PORTABLE MICRO POWER METER THEREFOR

(71) Applicant: Li-Ho YAO, Taipei (TW)

(72) Inventor: Li-Ho YAO, Taipei (TW)

(21) Appl. No.: 13/920,205

(22) Filed: Jun. 18, 2013

(30) Foreign Application Priority Data
Jul. 10, 2012 (TW) 101124702

(51) Int. Cl. G05B 13/02

(52) U.S. Cl. CPC G05B 13/02
USPC 700/286

(57) ABSTRACT

A portable micro power meter is applied to a personalized power resources management system and has a power detection device including multiple power adapters connected therewith, and a power-recording device selectively connected with the power detection device. The power detection device detects the power flowing through each power adapter, and the power-recording device receives and stores the information of the power flowing through each power adapter of the power detection device. As the power detection device can detect the information of the power flowing from and to a smart electric grid through each power adapter and the power-recording device can be selectively connected to the power detection device of different portable micro power meters, the portable micro power meter can be repeatedly applied to non-specific power-generating or power-consuming equipment.

The current application claims a foreign priority to the patent application of Taiwan No. 101124702 filed on Jul. 10, 2012.

### BACKGROUND OF THE INVENTION

1. Field of the Invention

The present invention relates to a power management system and more particularly to a personalized power resource management system and a portable micro power meter therefore effective in portable metering of personal energy flow measurement.

2. Description of the Related Art

Due to the aggravated issues of energy shortage and global warming in recent years, people gradually realize the concepts and importance of carbon emission, carbon footprint and carbon right. How to effectively manage energy resources inevitably becomes a worldwide subject that is discussed enthusiastically by every country. Hence, so far, specialists and scholars have proposed a concept of smart electric grid. The so-called smart electric grid indicates an advanced electric grid system integrating power generation, power transmission, power distribution and subscribers, and has the advantages of automation and informatization to attain the functions of self-monitoring, self-diagnosis and self-repair.

To make the smart electric grid as effective as expected, it is critical to establish an advanced metering infrastructure (AMI). The AMI is composed of multiple smart meters, a data network supporting bi-directional communication and an automatic meter-reading control center. The main concern for such infrastructure to be in place targets at more flexibly utilizing power at the subscribers' ends and more effectively and economically generating power at the supplier's ends. Therefore, the smart electric grid shuts down certain unnecessary electric appliances to reduce power demand during peak power demand, and rearranges the structure associated with power generation and power utilization, thereby ensuring energy conservation and sustainable electricity development.

People normally acquire calories from food during daily life and converts calories into kinetic energy through exercise, such as riding a bicycle or exercising with any fitness equipment. Calories were burned only in the form of body heat dissipated from the skin in the past. While current energy conversion technique becomes well-developed, a power generator and a power-storing device can be further mounted on a bicycle or any fitness equipment. As disclosed in Taiwan utility model patent number M404033 entitled “Self power-generating structure of a treadmill”, Taiwan utility model patent number M408383 entitled “Power generator of fitness equipment” and Taiwan utility model patent number M409305 entitled “Fitness equipment having a power-generating function”, the kinetic energy generated through the operation of the power generator is converted into electricity and stored in the power-storing device.

Further from the technique disclosed in Taiwan utility model patent number M409860 entitled “Grid-connected self power-generating fitness equipment”, the electricity generated by the power generator may be further transmitted to a smart electric grid so that the electricity can be fully and effectively utilized by the smart electric grid after being allocated by the smart electric grid. From those disclosures, personalized fitness equipment has the functions of power generation and power storage and can be further connected to the smart electric grid to transmit the electricity generated by personal exercise to the smart electric grid.

In view of the advent of the era of high electricity price, the possibility of electricity directly taken as currency is just around the corner. However, the foregoing prior arts only record the power generated by each fitness equipment but fail to record the power generated by each user. Without the personalized power recording device, limitations imposed on the future development of pricing personal power for sale is somehow inevitable.

### SUMMARY OF THE INVENTION

An objective of the present invention is to provide a personalized power resource management system and a portable micro power meter therefore effective in portable metering of personal energy flow measurement. To achieve the foregoing objective, the personalized power resources management system has at least one power-generating unit and a power-recording device.

Each one of the at least one power-generating unit is adapted to electrically connect to and supply power to a smart electric grid and has a power-generating module and a power detection device.

The power detection device has a first housing. The first housing has multiple power adapters connected therewith, one of the power adapters is connected to the power-generating module, and another power adapter is adapted to connect to the smart electric grid.

The power detection device detects the power transmitted from the power-generating module to the smart electric grid through the corresponding power adapters.

The power-recording device is selectively connected to the power detection device of one of the at least one power-generating unit to receive and store information of the power transmitted to the smart electric grid, and has an enclosure.

With the personalized power resources management system, the power-recording device can record power generated from personal exercise and transmitted to the smart electric grid and can be detached from a power-generating unit after user's exercise is finished to enhance the portability of the power-recording device. Accordingly, the power-recording device can be repeatedly operated on non-specific power-generating units to facilitate summing up the power generated through users' exercise on the non-specific power-generating units.

To achieve the foregoing objective, the portable micro power meter has a power detection device and a power-recording device.

The power detection device has a housing. The housing has multiple power adapters connected therewith. The power detection device detects the power transmitted through two of the power adapters.

The power-recording device is selectively connected to the power detection device to receive and to store the information of the power transmitted through the power detection device and the corresponding power adapters, and has an enclosure.

The portable micro power meter is applicable to the foregoing power-generating unit. When the portable micro power meter is operated, two of the power adapters of the power detection device of the portable micro power meter are respectively connected to the smart electric grid and the foregoing power-generating unit. The power-recording device can record the power generated by the power-generating unit and transmitted to the smart electric grid, and can be repeatedly operated on non-specific power-generating units so as to easily calculate the total power generated through users' exercise on the non-specific power-generating units.

Other objectives, advantages and novel features of the invention will become more apparent from the following detailed description when taken in conjunction with the accompanying drawings.

### BRIEF DESCRIPTION OF THE DRAWINGS

FIG. 1 is a system architecture diagram of a personalized power resources management system in accordance with the present invention;

FIG. 2 is a perspective view of the personalized power resources management system in FIG. 1;

FIG. 3 is a functional block diagram of the personalized power resources management system in FIG. 1 with a power-generating unit and a power-recording device directly connected;

FIG. 4 is a functional block diagram of the personalized power resources management system in FIG. 1 with the power-generating unit and the power-recording device connected through a communication means;

FIG. 5 is a functional diagram of the personalized power resources management system in FIG. 1 with a power-consuming unit and a power-recording device directly connected;

FIG. 6 is a functional block diagram of the personalized power resources management system in FIG. 5 with the power-consuming unit and the power-recording device connected through a communication means;

FIG. 7 is a perspective view of a portable micro power meter in accordance with the present invention;

FIG. 8 is an exploded perspective view of the portable micro power meter in FIG. 7;

FIG. 9 is an exploded perspective view of a power detection device of the portable micro power meter in FIG. 7; and

FIG. 10 is an exploded perspective view of a power-recording device of the portable micro power meter in FIG. 7.

### DETAILED DESCRIPTION OF THE INVENTION

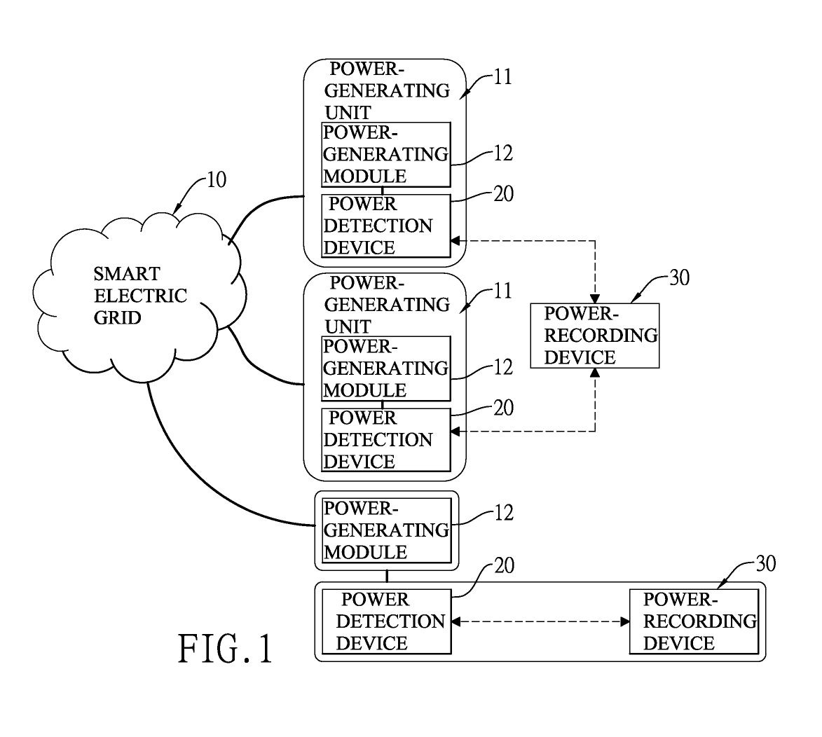

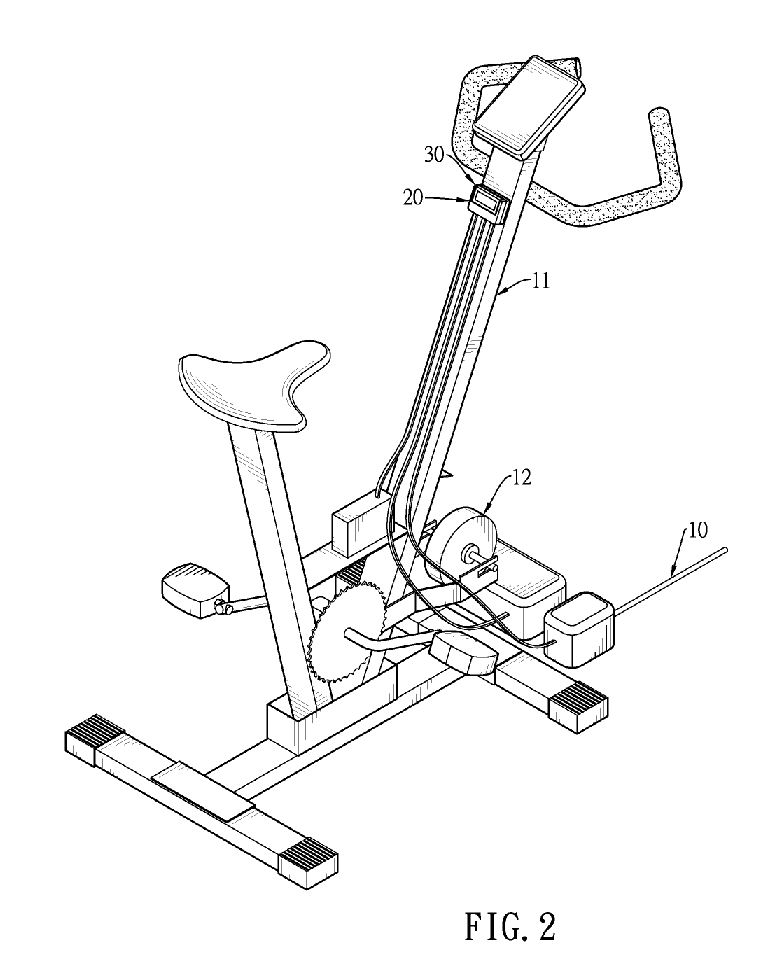

With reference to FIGS. 1 to 3, a personalized power resources management system in accordance with the present invention represents a system configuration at a power-generating phase, and has at least one power-generating unit 11 and a power-recording device 30.

Each one of the at least one power-generating unit 11 is electrically connected to and supplies power to a smart electric grid 10 and has a power-generating module 12 and a power detection device 20. The power detection device 20 has a first housing 21. The first housing 21 has multiple power adapters 22 connected therewith. The power adapters 22 have different connection interfaces and two of the power adapters 22 are respectively connected to the power-generating module 12 and the smart electric grid 10. The power detection device 20 detects the power transmitted from the power-generating module 12 to the smart electric grid 10 through the corresponding power adapters 22. In the present embodiment, the first housing 21 of the power detection device 20 has a first connector 23 connected therewith. The power detection device 20 of each one of the at least one power-generating unit 11 further has a detection circuit board 24. The detection circuit board 24 is electrically connected to the power adapters 22 and the first connector 23, and has a current detection circuit 25 and a voltage detection circuit 26 for detecting the power transmitted from the power-generating module 12 to the smart electric grid 10 through the corresponding power adapters 22.

The power-recording device 30 is selectively connected to the power detection device 20 of one of the at least one power-generating unit 11 to receive and store information of the power transmitted to the smart electric grid 10, and has an enclosure 31. In the present embodiment, the enclosure 31 of the power-recording device 30 has a second connector 32 corresponding to the first connector 23 of the power detection device 20 for the second connector 32 to selectively connect with the first connector 23 of the power detection device 20 of one of the at least one power-generating unit 11. The power-recording device 30 receives the information of the power transmitted to the smart electric grid 10 through the first connector 23 and the second connector 32, and further has a microprocessor 33, a memory module 34, a display module 35 and a communication port 36. The power-recording device 30 may be detachably connected to the power detection device 20 of each one of the at least one power-generating unit 11 to ensure a plug-and-play operation or may be integrated with the power detection device 30 as a stationary part of each one of the at least one power-generating unit 11.

The microprocessor 33 is electrically connected to the second connector 32 to receive information of the power transmitted from the power-generating module 12 of each one of the at least one connected power-generating unit to the smart electric grid 10 through the corresponding power adapters 22 and to convert the information into recorded power data. The microprocessor 33 is built in with a generated power calculation procedure for converting the recorded power data into an equivalent currency value and storing the currency value.

The memory module 34 is electrically connected to the microprocessor 33 to store the recorded power data.

The display module 35 is electrically connected to the microprocessor 33 to display the recorded power data.

The communication port 36 is electrically connected to the microprocessor 33 to transmit the recorded power data.

According to the foregoing structure, the power-recording device 30 can record the information of the power respectively generated through the at least one power-generating unit 11 and transmitted to the smart electric grid 10, is portable, and can be removed from the connected power-generating unit 11 after the power-recording device 30 is done with the recording of the power generated by the connected power-generating unit 11 so that the power-recording device 30 can be repeatedly applied to record the power generated by the at least one power-generating unit 11 and it is convenient for the power-recording device 30 to sum up a total power generated by the at least one power-generating unit 11.

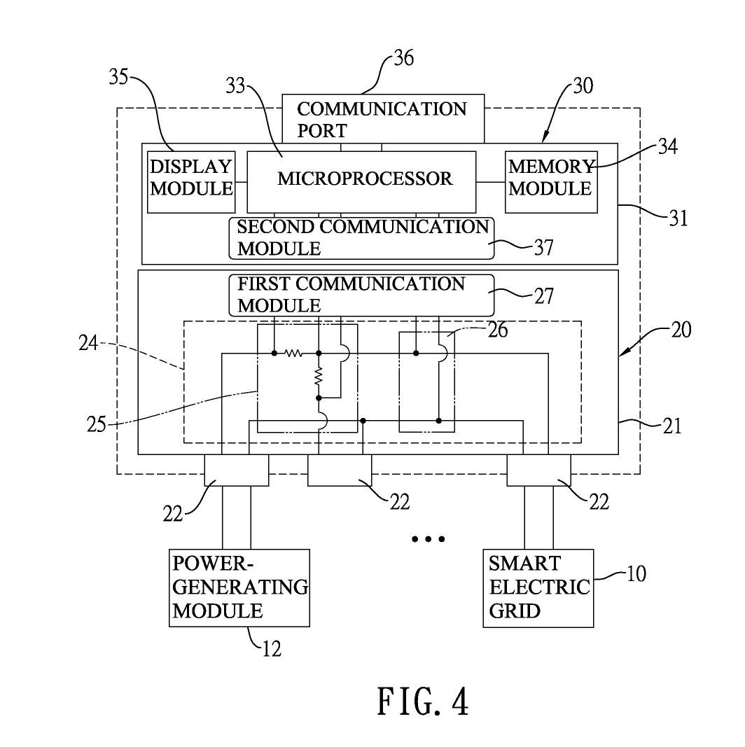

With reference to FIG. 4, the first connector 23 of the power detection device 20 and the second connector 32 of the power-recording device 30 in FIG.

3 are respectively replaced by a first communication module 27 and a second communication module 37. The second communication module 37 is selectively connected with the first communication module 27 of the power detection device 20 of one of the at least one power-generating unit 11. The first communication module 27 and the second communication module 37 may be implemented to comply with the requirement of Bluetooth, Wibree, Zigbee, IEEE802.5.14, WiFi, wireless USB, RF or the like.

In the present embodiment, with the first communication module 27 and the second communication module 37, the power-recording device 30 can receive the information of the power respectively transmitted to the smart electric grid 10 and detected by the power detection device 20 of the at least one power-generating unit 11 without having to directly connect the power-recording device 30 with the power detection device 20 of each one of the at least one power-generating unit 11.

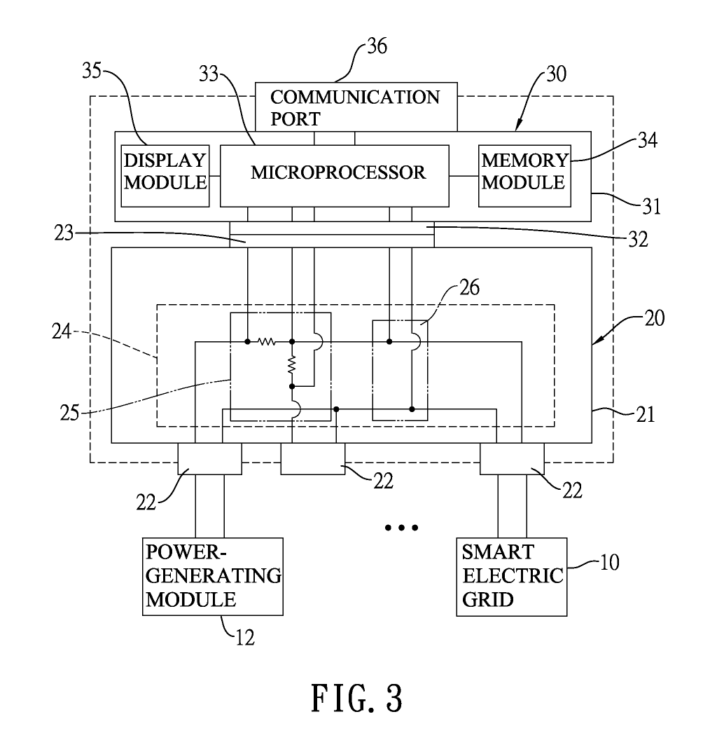

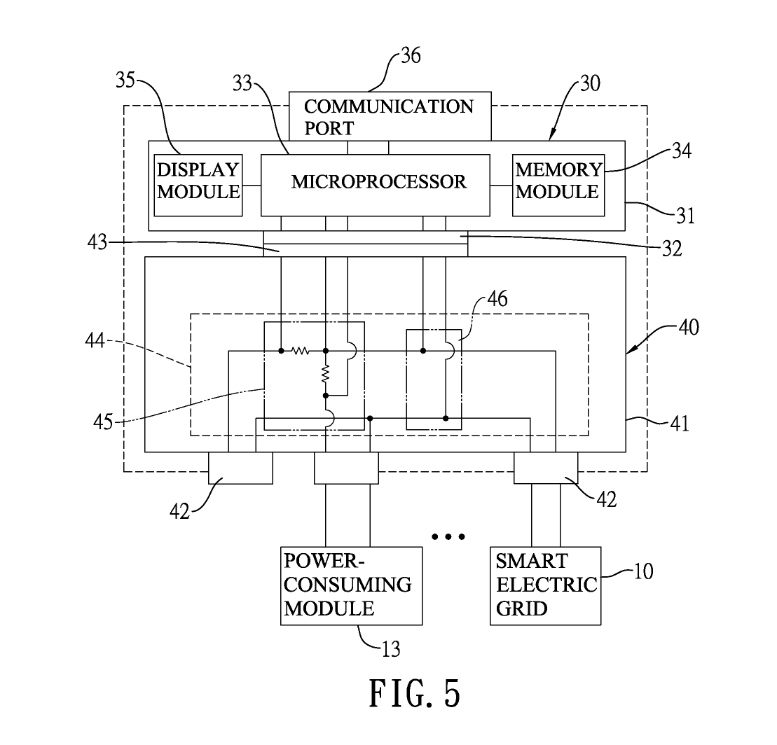

With reference to FIG. 5, the personalized power resource management system represents a system configuration at a power-consuming phase, and is similar to that in FIG. 3 except that the at least one power-generating unit 11 is replaced by at least one power-consuming unit. Each one of the at least one power-consuming unit is the same as each one of the at least one power-generating unit 11. However, to distinguish the distinction between the power-consuming unit and the power-generating unit in operation, it is noted that different reference numerals are given to the identical elements in the power-consuming unit and in the power-generating unit. Each one of the at least one power-consuming unit is electrically connected to the smart electric grid 10 and has a power-consuming module 13 and a power detection device 40. The power detection device 40 has a second housing 41. The second housing 41 has multiple power adapters 42 connected therewith. The power adapters 42 are respectively connected to the power-consuming module 13 and the smart electric grid 10. The power detection device 40 detects the power transmitted from the smart electric grid 10 to the power-consuming module 13 through two of the power adapters 42. In the present embodiment, the second housing 41 of the power detection device 40 has a first connector 43 connected therewith. The power detection device 40 of the power-consuming unit further has a detection circuit board 44. The detection circuit board 44 is electrically connected to the power adapters 42 and the first connector 43 and has a current detection circuit 45 and a voltage detection circuit 46 for detecting the power supplied from the smart electric grid 10 to the power-consuming module 13 through the corresponding power adapters 42.

The foregoing power-recording device 30 is selectively connected to the power detection device 40 of one of the at least one power-consuming unit to receive and store the information of the power supplied from the smart electric grid 10.

As each one of the at least one power-consuming unit has a first connector 43, the second connector 32 of the power detection device 30 is selectively connected to the first connector 43 of one of the at least one power-consuming unit to receive and store the information of the power transmitted from the smart electric grid 10. In the present embodiment, the microprocessor 33 receives information of the power supplied from the smart electric grid 10 to the power-consuming module 13 of each one of the at least one power-consuming unit through the corresponding power adapters 42 and converts the information into recorded power data. The microprocessor 33 is built in with a consumed power calculation procedure for converting the recorded power data into an equivalent currency value, which can be deducted from the stored currency value.

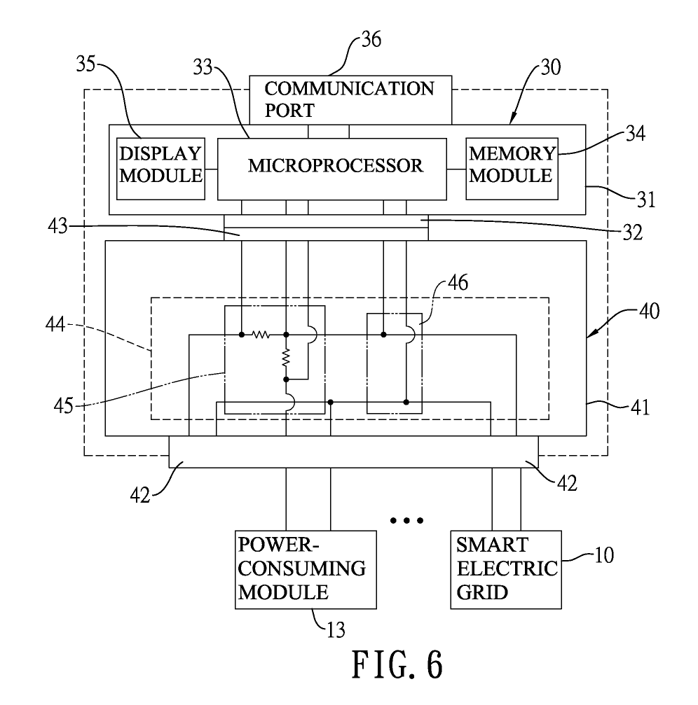

With reference to FIG. 6, unlike the power adapters 22, 42 separately arranged on the power detection device 20, 40 in FIGS. 3 and 5, the power adapters 42 of the present embodiment are integrally formed on the power detection device 40.

With further reference to FIGS. 3 to 6, as the power detection device 20, 40 of each one of the at least one power-generating unit 11 is identical to that of each one of the at least one power-consuming unit, the power detection device 20, 40 with identical model number can be manufactured by mass production in practical applications and the generated power calculation procedure and the consumed power calculation procedure embedded in the microprocessor 33 of the power-recording device 30 can be altered and tailored to meet specific needs.

From the foregoing structure, the present invention treats electricity as a currency for transaction, which possesses liquidity and value. The smart electric grid 10 can be considered as a bank for storing power generated by each of the at least one power-generating module 12 from users' exercise. Hence, a user can enable each one of the at least one power-generating unit 11 to supply the power generated by the power-generating unit 11 to the smart electric grid 10, let the power-recording device 30 record the generated power in terms of watt-hour and convert the recorded watt-hours of the generated power into an equivalent currency value, so that the smart electric grid can directly supply power to at least one power-consuming unit according to the currency value and it is unnecessary for the user to spend additional money for workout using the at least one power-consuming unit. Given the personalized power resources management system of the present invention, it is convenient for users to sum up the total power selectively generated through at least one power-generating unit and utilize the generated power through at least one power-consuming unit.

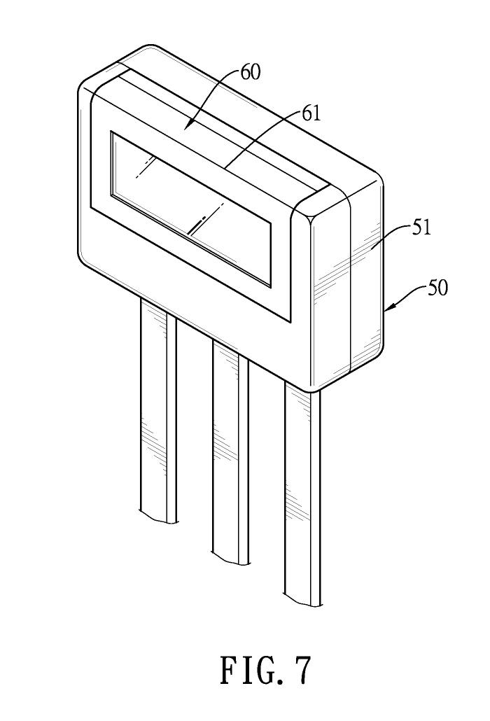

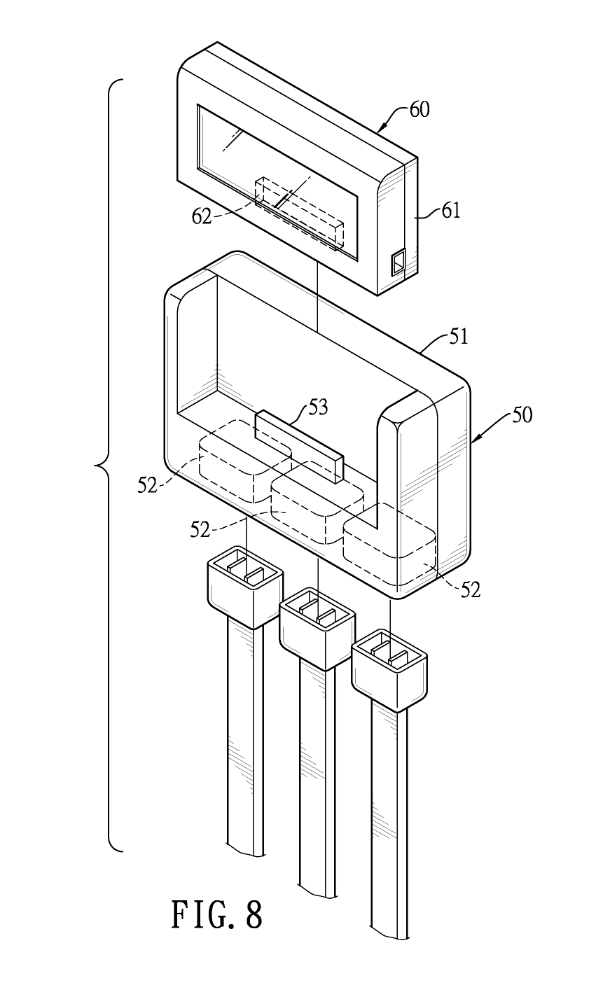

With reference to FIGS. 7 and 8, a portable micro power meter in accordance with the present invention has a power detection device 50 and a power-recording device 60.

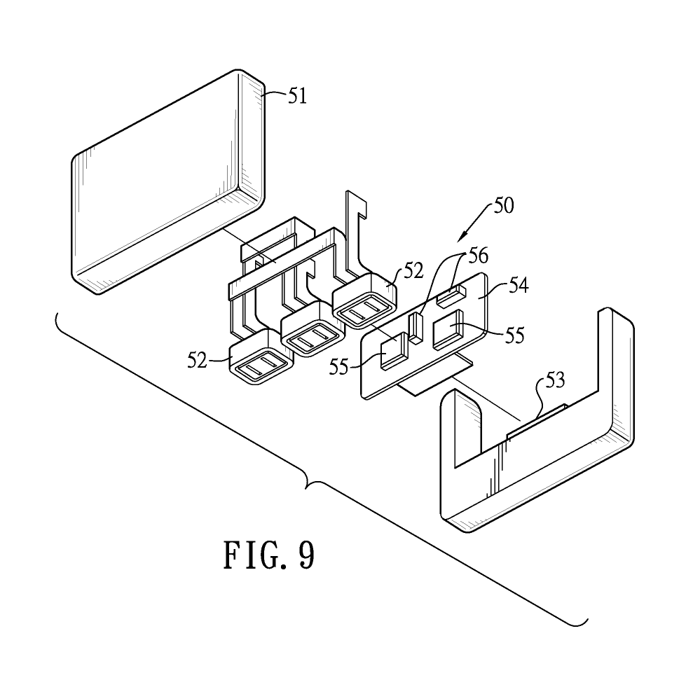

The power detection device 50 has a housing 51. The housing 51 has multiple power adapters 52 connected therewith. The power detection device 50 detects a power transmitted through two of the power adapters 52. In the present embodiment, the housing 51 of the power detection device 50 has a first connector 53 connected therewith. With reference to FIG. 9, the power detection device 50 further has a detection circuit board 54. The detection circuit board 54 is electrically connected to the power adapters 52 and the first connector 53 and has a current detection circuit 55 and a voltage detection circuit 56 for detecting the power transmitted through the corresponding power adapters 52.

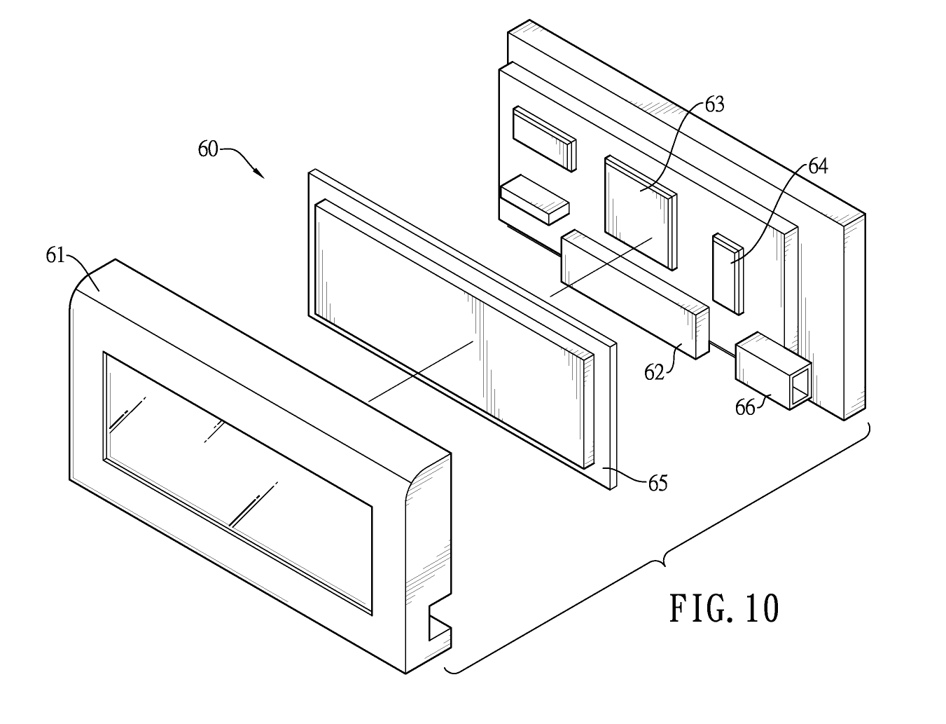

The power-recording device 60 is selectively connected to the power detection device 50 to receive and store the information of the power transmitted through the power detection device 50 and the corresponding power adapters 52, and has an enclosure 61. In the present embodiment, the enclosure 61 of the power-recording device 60 has a second connector 62 corresponding to the first connector 53 of the power detection device 50 for the second connector 62 to selectively connect with the first connector 53 of the power detection device 50. The power-recording device 60 receives and stores the information of the power transmitted through the power adapters 52 of the power detection device 50, the first connector 53 and the second connector 62. With reference to FIG. 10, the power-recording device 60 further has a microprocessor 63, a memory module 64, a display module 65 and a communication port 66.

The microprocessor 63 is electrically connected to the second connector 62 to receive information of the power transmitted through the corresponding power adapters 52 of the power detection device 50 and to convert the information into recorded power data. The microprocessor 63 is built in with a generated power calculation procedure and a consumed power calculation procedure. The generated power calculation procedure converts the recorded power data into an equivalent currency value and adds the equivalent currency value to the stored currency value. The consumed power calculation procedure deducts the stored currency value according to the recorded power data.

The memory module 64 is electrically connected to the microprocessor 63 to store the recorded power data.

The display module 65 is electrically connected to the microprocessor 63 to display the recorded power data.

The communication port 66 is electrically connected to the microprocessor 63 to transmit the recorded power data.

Moreover, the power adapters 52 of the power detection device 50 can be integrally formed as a single power adapter.

The first connector 53 and the second connector 62 can be respectively replaced by a first communication module and a second communication module. The second communication module is selectively connected to the first communication module of the power detection device through a communication link so that the power-recording device 60 can receive the information of the power transmitted through the corresponding power adapters 52 of the power detection device 50 without directly connecting the power-recording device 60 with the power detection device 50.

The portable micro power meter is applicable to the foregoing power-generating unit 11, and the power detection device 50 thereof can be connected to the power-recording device 60 through the first connector 53 and the second connector 62 to store the information of the power flowing through the corresponding power adapters in the power-recording device 60. Prior to the operation of the portable micro power meter, the power adapters 52 are respectively connected to the smart electric grid 10 and one of the at least one power-generating module 12, and the power-recording device 60 can record the power generated by the power-generating module and transmitted to the smart electric grid. After detached from the power detection device 50, the power-recording device 60 is further plugged in the power detection device 50 connected with a power-consuming module 13 to record the power supplied from the smart electric grid to the power-consuming module 13.

Accordingly, by connecting to the power detection device 50 through a non-specific connection means, the power-recording device 60 can be operated on a non-specific power-generating unit or power-consuming unit so that the power generated by a person using at least one power-generating unit can be conveniently summed up and deducted by the user for using other power-consuming unit.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A personalized power resources management system comprising:
at least one power-generating unit, each one of the at least one power-generating unit adapted to electrically connect to and supply power to a smart electric grid, and having:
a power-generating module; and
a power detection device having a first housing, wherein the first housing has multiple power adapters connected therewith, one of the power adapters is connected to the power-generating module, and another power adapter is adapted to connect to the smart electric grid, and
the power detection device detects the power transmitted from the power-generating module to the smart electric grid through the corresponding power adapters; and
a power-recording device selectively connected to the power detection device of one of the at least one power-generating unit to receive and store information of the power transmitted to the smart electric grid, and having an enclosure.

2. The personalized power resources management system as claimed in claim 1, wherein
the first housing of the power detection device of each one of the at least one power-generating unit has a first connector connected therewith; and
the enclosure of the power-recording device has a second connector corresponding to the first connector of the power detection device for the second connector to selectively connect with the first connector of the power detection device of one of the at least one power-generating unit so that the power-recording device receives the information of the power transmitted to the smart electric grid through the first connector and the second connector.

3. The personalized power resources management system as claimed in claim 2, wherein the power-recording device further has:
a microprocessor electrically connected to the second connector to receive the information of the power transmitted from the power-generating module of each one of the at least one connected power-generating unit to the smart electric grid through the corresponding power adapters and to convert the information into recorded power data;
a memory module electrically connected to the microprocessor to store the recorded power data; and
a display module electrically connected to the microprocessor to display the recorded power data.

4. The personalized power resources management system as claimed in claim 3, wherein the power detection device of each one of the at least one power-generating unit further has a detection circuit board electrically connected to the power adapters and the first connector and having a current detection circuit and a voltage detection circuit for detecting the power transmitted from the power-generating module to the smart electric grid through the corresponding power adapters.

5. The personalized power resources management system as claimed in claim 4, wherein the power-recording device further has a communication port electrically connected to the microprocessor to transmit the recorded power data.

6. The personalized power resources management system as claimed in claim 5, wherein the microprocessor is built in with a generated power calculation procedure for converting the recorded power data into an equivalent currency value and storing the currency value.

7. The personalized power resources management system as claimed in claim 1, wherein
the power detection device of each one of the at least one power-generating unit has a first communication module; and
the power-recording device has a second communication module corresponding to the first communication module of the power detection device, and the second communication module is selectively connected with the first communication module of the power detection device of one of the at least one power-generating unit to receive the information of the power transmitted to the smart electric grid through the first communication module and the second communication module.

8. The personalized power resources management system as claimed in claim 7, wherein the power-recording device further has:
a microprocessor electrically connected to the second communication module to receive the information of the power transmitted from the power-generating module of each one of the at least one connected power-generating unit to the smart electric grid through the corresponding power adapters and to convert the information into recorded power data;
a memory module electrically connected to the microprocessor to store the recorded power data; and
a display module electrically connected to the microprocessor to display the recorded power data.

9. The personalized power resources management system as claimed in claim 8, wherein the power detection device of each one of the at least one power-generating unit further has a detection circuit board electrically connected to the power adapters and the first communication module and having a current detection circuit and a voltage detection circuit for detecting the power transmitted from the power-generating module to the smart electric grid through the corresponding power adapters.

10. The personalized power resources management system as claimed in claim 9, wherein the power-recording device further has a communication port electrically connected to the microprocessor to transmit the recorded power data.

11. The personalized power resources management system as claimed in claim 10, wherein the microprocessor is built in with a generated power calculation procedure for converting the recorded power data into an equivalent currency value and storing the currency value.

12. The personalized power resources management system as claimed in claim 3, further comprising:
at least one power-consuming unit, each one of the at least one power-consuming unit adapted to electrically connect to the smart electric grid and having:
a power-consuming module; and
a power detection device having a second housing, wherein the second housing has multiple power adapters connected therewith, one of the power adapters is connected to the power-consuming module, and another power adapter is adapted to connect to the smart electric grid and the power detection device detects the power transmitted from the smart electric grid to the power-consuming module through the corresponding power adapters;
wherein the power-recording device is selectively connected to the power detection device of one of the at least one power-consuming unit to receive and store the information of the power supplied from the smart electric grid.

13. The personalized power resources management system as claimed in claim 4, further comprising:
at least one power-consuming unit, each one of the at least one power-consuming unit adapted to electrically connect to the smart electric grid and having:
a power-consuming module; and
a power detection device having a second housing, wherein the second housing has multiple power adapters connected therewith, one of the power adapters is connected to the power-consuming module, and another power adapter is adapted to connect to the smart electric grid and the power detection device detects the power transmitted from the smart electric grid to the power-consuming module through the corresponding power adapters;
wherein the power-recording device is selectively connected to the power detection device of one of the at least one power-consuming unit to receive and store the information of the power supplied from the smart electric grid.

14. The personalized power resources management system as claimed in claim 5, further comprising:
at least one power-consuming unit, each one of the at least one power-consuming unit adapted to electrically connect to the smart electric grid and having:
a power-consuming module; and
a power detection device having a second housing, wherein the second housing has multiple power adapters connected therewith, one of the power adapters is connected to the power-consuming module, and another power adapter is adapted to connect to the smart electric grid and the power detection device detects the power transmitted from the smart electric grid to the power-consuming module through the corresponding power adapters;
wherein the power-recording device is selectively connected to the power detection device of one of the at least one power-consuming unit to receive and store the information of the power supplied from the smart electric grid.

15. The personalized power resources management system as claimed in claim 6, further comprising:
at least one power-consuming unit, each one of the at least one power-consuming unit adapted to electrically connect to the smart electric grid and having:
a power-consuming module; and
a power detection device having a second housing, wherein the second housing has multiple power adapters connected therewith, one of the power adapters is connected to the power-consuming module, and another power adapter is adapted to connect to the smart electric grid and the power detection device detects the power transmitted from the smart electric grid to the power-consuming module through the corresponding power adapters;
wherein the power-recording device is selectively connected to the power detection device of one of the at least one power-consuming unit to receive and store the information of the power supplied from the smart electric grid.

16. The personalized power resources management system as claimed in claim 12, wherein
the second housing of the power detection device of each one of the at least one power-consuming unit has a first connector connected therewith; and
the power-recording device has a second connector corresponding to the first connector of the power detection device for the second connector to selectively connect with the first connector of the power detection device of one of the at least one power-consuming unit so that the power-recording device receives the information of the power supplied from the smart electric grid through the first connector and the second connector.

17. The personalized power resources management system as claimed in claim 13, wherein
the second housing of the power detection device of each one of the at least one power-consuming unit has a first connector connected therewith; and
the power-recording device has a second connector corresponding to the first connector of the power detection device for the second connector to selectively connect with the first connector of the power detection device of one of the at least one power-consuming unit so that the power-recording device receives the information of the power supplied from the smart electric grid through the first connector and the second connector.

18. The personalized power resources management system as claimed in claim 14, wherein
the second housing of the power detection device of each one of the at least one power-consuming unit has a first connector connected therewith; and
the power-recording device has a second connector corresponding to the first connector of the power detection device for the second connector to selectively connect with the first connector of the power detection device of one of the at least one power-consuming unit so that the power-recording device receives the information of the power supplied from the smart electric grid through the first connector and the second connector.

19. The personalized power resources management system as claimed in claim 15, wherein
the second housing of the power detection device of each one of the at least one power-consuming unit has a first connector connected therewith; and
the power-recording device has a second connector corresponding to the first connector of the power detection device for the second connector to selectively connect with the first connector of the power detection device of one of the at least one power-consuming unit so that the power-recording device receives the information of the power supplied from the smart electric grid through the first connector and the second connector.

20. The personalized power resources management system as claimed in claim 16, wherein the power detection device of each one of the at least one power-consuming unit further has a detection circuit board electrically connected to the power adapters and the first connector and having a current detection circuit and a voltage detection circuit for detecting the power supplied from the smart electric grid to the power-consuming unit through the corresponding power adapters.

21. The personalized power resources management system as claimed in claim 17, wherein the power detection device of each one of the at least one power-consuming unit further has a detection circuit board electrically connected to the power adapters and the first connector and having a current detection circuit and a voltage detection circuit for detecting the power supplied from the smart electric grid to the power-consuming unit through the corresponding power adapters.

22. The personalized power resources management system as claimed in claim 18, wherein the power detection device of each one of the at least one power-consuming unit further has a detection circuit board electrically connected to the power adapters and the first connector and having a current detection circuit and a voltage detection circuit for detecting the power supplied from the smart electric grid to the power-consuming unit through the corresponding power adapters.

23. The personalized power resources management system as claimed in claim 19, wherein the power detection device of each one of the at least one power-consuming unit further has a detection circuit board electrically connected to the power adapters and the first connector and having a current detection circuit and a voltage detection circuit for detecting the power supplied from the smart electric grid to the power-consuming unit through the corresponding power adapters.

24. The personalized power resources management system as claimed in claim 20, wherein the microprocessor is built in with a consumed power calculation procedure for deducting a currency value converted from the recorded power data supplied from the smart electric grid from the stored currency value.

25. The personalized power resources management system as claimed in claim 21, wherein the microprocessor is built in with a consumed power calculation procedure for deducting a currency value converted from the recorded power data supplied from the smart electric grid from the stored currency value.

26. The personalized power resources management system as claimed in claim 22, wherein the microprocessor is built in with a consumed power calculation procedure for deducting a currency value converted from the recorded power data supplied from the smart electric grid from the stored currency value.

27. The personalized power resources management system as claimed in claim 23, wherein the microprocessor is built in with a consumed power calculation procedure for deducting a currency value converted from the recorded power data supplied from the smart electric grid from the stored currency value.

28. The personalized power resources management system as claimed in claim 8, further comprising:
at least one power-consuming unit, each one of the at least one power-consuming unit adapted to electrically connect to and having:
a power-consuming module; and
a power detection device having a second housing, wherein the second housing has multiple power adapters connected therewith, one of the power adapters is connected to the power-consuming module, and another power adapter is adapted to connect to the smart electric grid and the power detection device detects the power transmitted from the smart electric grid to the power-consuming module through the corresponding power adapters;
wherein the power-recording device is selectively connected to the power detection device of one of the at least one power-consuming unit to receive and store the information of the power supplied from the smart electric grid.

29. The personalized power resources management system as claimed in claim 9, further comprising:
at least one power-consuming unit, each one of the at least one power-consuming unit adapted to electrically connect to and having:
a power-consuming module; and
a power detection device having a second housing, wherein the second housing has multiple power adapters connected therewith, one of the power adapters is connected to the power-consuming module, and another power adapter is adapted to connect to the smart electric grid and the power detection device detects the power transmitted from the smart electric grid to the power-consuming module through the corresponding power adapters;
wherein the power-recording device is selectively connected to the power detection device of one of the at least one power-consuming unit to receive and store the information of the power supplied from the smart electric grid.

30. The personalized power resources management system as claimed in claim 10, further comprising:
at least one power-consuming unit, each one of the at least one power-consuming unit adapted to electrically connect to and having:
a power-consuming module; and
a power detection device having a second housing, wherein the second housing has multiple power adapters connected therewith, one of the power adapters is connected to the power-consuming module, and another power adapter is adapted to connect to the smart electric grid and the power detection device detects the power transmitted from the smart electric grid to the power-consuming module through the corresponding power adapters;
wherein the power-recording device is selectively connected to the power detection device of one of the at least one power-consuming unit to receive and store the information of the power supplied from the smart electric grid.

31. The personalized power resources management system as claimed in claim 11, further comprising:
at least one power-consuming unit, each one of the at least one power-consuming unit adapted to electrically connect to and having:
a power-consuming module; and
a power detection device having a second housing, wherein the second housing has multiple power adapters connected therewith, one of the power adapters is connected to the power-consuming module, and another power adapter is adapted to connect to the smart electric grid and the power detection device detects the power transmitted from the smart electric grid to the power-consuming module through the corresponding power adapters;
wherein the power-recording device is selectively connected to the power detection device of one of the at least one power-consuming unit to receive and store the information of the power supplied from the smart electric grid.

32. The personalized power resources management system as claimed in claim 28, wherein
the power detection device of each one of the at least one power-consuming unit has a first communication module; and
the power-recording device has a second communication module corresponding to the first communication module of the power detection device, and the second communication module is selectively connected with the first communication module of the power detection device of one of the at least one power-consuming unit to receive the information of the power supplied from the smart electric grid through the first communication module and the second communication module.

33. The personalized power resources management system as claimed in claim 29, wherein
the power detection device of each one of the at least one power-consuming unit has a first communication module; and
the power-recording device has a second communication module corresponding to the first communication module of the power detection device, and the second communication module is selectively connected with the first communication module of the power detection device of one of the at least one power-consuming unit to receive the information of the power supplied from the smart electric grid through the first communication module and the second communication module.

34. The personalized power resources management system as claimed in claim 30, wherein
the power detection device of each one of the at least one power-consuming unit has a first communication module; and
the power-recording device has a second communication module corresponding to the first communication module of the power detection device, and the second communication module is selectively connected with the first communication module of the power detection device of one of the at least one power-consuming unit to receive the information of the power supplied from the smart electric grid through the first communication module and the second communication module.

35. The personalized power resources management system as claimed in claim 31, wherein
the power detection device of each one of the at least one power-consuming unit has a first communication module; and
the power-recording device has a second communication module corresponding to the first communication module of the power detection device, and the second communication module is selectively connected with the first communication module of the power detection device of one of the at least one power-consuming unit to receive the information of the power supplied from the smart electric grid through the first communication module and the second communication module.

36. The personalized power resources management system as claimed in claim 32, wherein the power detection device of each one of the at least one power-consuming unit further has a detection circuit board electrically connected to the power adapters and the first communication module and having a current detection circuit and a voltage detection circuit for detecting the power supplied from the smart electric grid to the power-consuming unit through the corresponding power adapters.

37. The personalized power resources management system as claimed in claim 33, wherein the power detection device of each one of the at least one power-consuming unit further has a detection circuit board electrically connected to the power adapters and the first communication module and having a current detection circuit and a voltage detection circuit for detecting the power supplied from the smart electric grid to the power-consuming unit through the corresponding power adapters.

38. The personalized power resources management system as claimed in claim 34, wherein the power detection device of each one of the at least one power-consuming unit further has a detection circuit board electrically connected to the power adapters and the first communication module and having a current detection circuit and a voltage detection circuit for detecting the power supplied from the smart electric grid to the power-consuming unit through the corresponding power adapters.

39. The personalized power resources management system as claimed in claim 35, wherein the power detection device of each one of the at least one power-consuming unit further has a detection circuit board electrically connected to the power adapters and the first communication module and having a current detection circuit and a voltage detection circuit for detecting the power supplied from the smart electric grid to the power-consuming unit through the corresponding power adapters.

40. The personalized power resources management system as claimed in claim 36, wherein the microprocessor is built in with a consumed power calculation procedure for deducting a currency value converted from the recorded power data supplied from the smart electric grid from the stored currency value.

41. The personalized power resources management system as claimed in claim 37, wherein the microprocessor is built in with a consumed power calculation procedure for deducting a currency value converted from the recorded power data supplied from the smart electric grid from the stored currency value.

42. The personalized power resources management system as claimed in claim 38, wherein the microprocessor is built in with a consumed power calculation procedure for deducting a currency value converted from the recorded power data supplied from the smart electric grid from the stored currency value.

43. The personalized power resources management system as claimed in claim 39, wherein the microprocessor is built in with a consumed power calculation procedure for deducting a currency value converted from the recorded power data supplied from the smart electric grid from the stored currency value.

44. The personalized power resources management system as claimed in claim 1, wherein the power adapters of the power detection device of each one of the at least one power-generating unit are integrally formed as a single power adapter.

45. The personalized power resources management system as claimed in claim 2, wherein the power adapters of the power detection device of each one of the at least one power-generating unit are integrally formed as a single power adapter.

46. The personalized power resources management system as claimed in claim 3, wherein the power adapters of the power detection device of each one of the at least one power-generating unit are integrally formed as a single power adapter.

47. The personalized power resources management system as claimed in claim 4, wherein the power adapters of the power detection device of each one of the at least one power-generating unit are integrally formed as a single power adapter.

48. The personalized power resources management system as claimed in claim 5, wherein the power adapters of the power detection device of each one of the at least one power-generating unit are integrally formed as a single power adapter.

49. The personalized power resources management system as claimed in claim 6, wherein the power adapters of the power detection device of each one of the at least one power-generating unit are integrally formed as a single power adapter.

50. The personalized power resources management system as claimed in claim 7, wherein the power adapters of the power detection device of each one of the at least one power-generating unit are integrally formed as a single power adapter.

51. The personalized power resources management system as claimed in claim 8, wherein the power adapters of the power detection device of each one of the at least one power-generating unit are integrally formed as a single power adapter.

52. The personalized power resources management system as claimed in claim 9, wherein the power adapters of the power detection device of each one of the at least one power-generating unit are integrally formed as a single power adapter.

53. The personalized power resources management system as claimed in claim 10, wherein the power adapters of the power detection device of each one of the at least one power-generating unit are integrally formed as a single power adapter.

54. The personalized power resources management system as claimed in claim 11, wherein the power adapters of the power detection device of each one of the at least one power-generating unit are integrally formed as a single power adapter.

55. The personalized power resources management system as claimed in claim 12, wherein
the power adapters of the power detection device of each one of the at least one power-generating unit are integrally formed as a single power adapter; and
the power adapters of the power detection device of each one of the at least one power-consuming unit are integrally formed as a single power adapter.

56. The personalized power resources management system as claimed in claim 13, wherein
the power adapters of the power detection device of each one of the at least one power-generating unit are integrally formed as a single power adapter; and
the power adapters of the power detection device of each one of the at least one power-consuming unit are integrally formed as a single power adapter.

57. The personalized power resources management system as claimed in claim 14, wherein
the power adapters of the power detection device of each one of the at least one power-generating unit are integrally formed as a single power adapter; and
the power adapters of the power detection device of each one of the at least one power-consuming unit are integrally formed as a single power adapter.

58. The personalized power resources management system as claimed in claim 15, wherein
the power adapters of the power detection device of each one of the at least one power-generating unit are integrally formed as a single power adapter; and
the power adapters of the power detection device of each one of the at least one power-consuming unit are integrally formed as a single power adapter.

59. The personalized power resources management system as claimed in claim 28, wherein
the power adapters of the power detection device of each one of the at least one power-generating unit are integrally formed as a single power adapter; and
the power adapters of the power detection device of each one of the at least one power-consuming unit are integrally formed as a single power adapter.

60. The personalized power resources management system as claimed in claim 29, wherein
the power adapters of the power detection device of each one of the at least one power-generating unit are integrally formed as a single power adapter; and
the power adapters of the power detection device of each one of the at least one power-consuming unit are integrally formed as a single power adapter.

61. The personalized power resources management system as claimed in claim 30, wherein
the power adapters of the power detection device of each one of the at least one power-generating unit are integrally formed as a single power adapter; and
the power adapters of the power detection device of each one of the at least one power-consuming unit are integrally formed as a single power adapter.

62. The personalized power resources management system as claimed in claim 31, wherein
the power adapters of the power detection device of each one of the at least one power-generating unit are integrally formed as a single power adapter; and
the power adapters of the power detection device of each one of the at least one power-consuming unit are integrally formed as a single power adapter.

63. A portable micro power meter comprising:
a power detection device having a housing, wherein the housing has multiple power adapters connected therewith, and the power detection device detects the power transmitted through two of the power adapters; and
a power-recording device selectively connected to the power detection device to receive and to store information of the power transmitted through the power detection device and the corresponding power adapters, and having an enclosure.

64. The portable micro power meter as claimed in claim 63, wherein
the housing of the power detection device has a first connector; and
the enclosure of the power-recording device has a second connector corresponding to the first connector of the power detection device for the second connector to selectively connect with the first connector of the power detection device so that the power-recording device receives the information of the power transmitted through the power adapters of the power detection device, the first connector and the second connector.

65. The portable micro power meter as claimed in claim 64, wherein the power-recording device further has:
a microprocessor electrically connected to the second connector to receive the information of the power transmitted through the corresponding power adapters and to convert the information into recorded power data;
a memory module electrically connected to the microprocessor to store the recorded power data; and
a display module electrically connected to the microprocessor to display the recorded power data.

66. The portable micro power meter as claimed in claim 65, wherein the power detection device further has a detection circuit board electrically connected to the power adapters and the first connector and having a current detection circuit and a voltage detection circuit for detecting power transmitted through the corresponding power adapters.

67. The portable micro power meter as claimed in claim 66, wherein the microprocessor is built in with a generated power calculation procedure for converting the recorded power data into an equivalent currency value and storing the currency value and a consumed power calculation procedure for deducting a currency value converted from the recorded power data from the stored currency value.

68. The portable micro power meter as claimed in claim 63, wherein
the power detection device has a first communication module;
the power-recording device has a second communication module corresponding to the first communication module of the power detection device, and the second communication module is selectively connected with the first communication module of the power detection device to receive the information of the power transmitted through the power adapters of the power detection device, the first communication module and the second communication module.

69. The portable micro power meter as claimed in claim 68, wherein the power-recording device further has:
a microprocessor electrically connected to the second communication module to receive the information of the power transmitted through the corresponding power adapters and to convert the information into recorded power data;
a memory module electrically connected to the microprocessor to store the recorded power data; and
a display module electrically connected to the microprocessor to display the recorded power data.

70. The portable micro power meter as claimed in claim 69, wherein the power detection device further has a detection circuit board electrically connected to the power adapters and the first communication module and having a current detection circuit and a voltage detection circuit for detecting the power transmitted through the corresponding power adapters.

71. The portable micro power meter as claimed in claim 70, wherein the microprocessor is built in with a generated power calculation procedure for converting the recorded power data into an equivalent currency value and storing the currency value and a consumed power calculation procedure for deducting a currency value converted from the recorded power data from the stored currency value.

72. The portable micro power meter as claimed in claim 63, wherein the power adapters of the power detection device are integrally formed as a single power adapter.

73. The portable micro power meter as claimed in claim 64, wherein the power adapters of the power detection device are integrally formed as a single power adapter.

74. The portable micro power meter as claimed in claim 65, wherein the power adapters of the power detection device are integrally formed as a single power adapter.

75. The portable micro power meter as claimed in claim 66, wherein the power adapters of the power detection device are integrally formed as a single power adapter.

76. The portable micro power meter as claimed in claim 67, wherein the power adapters of the power detection device are integrally formed as a single power adapter.

77. The portable micro power meter as claimed in claim 68, wherein the power adapters of the power detection device are integrally formed as a single power adapter.

78. The portable micro power meter as claimed in claim 69, wherein the power adapters of the power detection device are integrally formed as a single power adapter.

79. The portable micro power meter as claimed in claim 70, wherein the power adapters of the power detection device are integrally formed as a single power adapter.

80. The portable micro power meter as claimed in claim 71, wherein the power adapters of the power detection device are integrally formed as a single power adapter.

81. The portable micro power meter as claimed in claim 65, wherein the power-recording device further has a communication port electrically connected to the microprocessor to transmit the recorded power data.

82. The portable micro power meter as claimed in claim 66, wherein the power-recording device further has a communication port electrically connected to the microprocessor to transmit the recorded power data.

83. The portable micro power meter as claimed in claim 67, wherein the power-recording device further has a communication port electrically connected to the microprocessor to transmit the recorded power data.

84. The portable micro power meter as claimed in claim 68, wherein the power-recording device further has a communication port electrically connected to the microprocessor to transmit the recorded power data.

85. The portable micro power meter as claimed in claim 69, wherein the power-recording device further has a communication port electrically connected to the microprocessor to transmit the recorded power data.
